(19) United States
(12) Patent Application Publication
(10) Pub. No.: US 2025/0292972 A1
(43) Pub. Date: Sep. 18, 2025

(54) CAPACITOR COMPONENT, USE OF A CAPACITOR COMPONENT AND METHOD OF MANUFACTURING

(71) Applicant: TDK Electronics AG, Muenchen (DE)

(72) Inventors: Fabio Augusto Bueno De Camargo Mello, Müenchen (DE); Róbert Bösze, Tanaka (HU); Balázs Császár, Szombathely (HU)

(21) Appl. No.: 18/861,961

(22) PCT Filed: May 8, 2023
(86) PCT No.: PCT/EP2023/062126

§ 371 Date: Oct. 31, 2024

(30) Foreign Application Priority Data
May 9, 2022 (DE) 10 2022 111 476.7

(51) Int. Cl. H01G 9/00; H01G 9/10; H01G 9/12

(52) U.S. Cl. CPC H01G 9/0003; H01G 9/0029; H01G 9/10; H01G 9/12

(57) ABSTRACT

In an embodiment a capacitor component includes a first winding element and a heat sink, wherein the first winding element is in direct thermal contact with the heat sink.

### CROSS-REFERENCE TO RELATED APPLICATIONS

This patent application is a national phase filing under section 371 of PCT/EP2023/062126, filed May 8, 2023, which claims the priority of German patent application 102022111476.7, filed May 9, 2022, each of which is incorporated herein by reference in its entirety.

### TECHNICAL FIELD

The present invention refers to capacitor components, to use cases of capacitor components and to corresponding methods of manufacturing capacitor components.

### BACKGROUND

Capacitor components establish physical embodiments of capacitive components in electrical circuits. Generally, capacitor components shall have good electrical and mechanical properties such as a high capacity, small spatial dimensions and mechanical robustness. Further, it is desired that capacitor components withstand high current densities.

Capacitor components can be used in DC-link applications, e.g. in hybrid or electric vehicles, where electric energy is stored in a battery and needed by an electric motor, as well as DC-link applications on power supplies. An inverter electrically converts the stored electric DC energy from the battery or available from e.g. a rectifier to the corresponding voltages and currents needed by the electric motor. However, during the operation of such an inverter, ripples or spikes can appear in voltages and/or currents. Corresponding capacitor components help to reduce the detrimental effects of the spikes and ripple.

From WO 2013/026645 A2 or from WO 2018/122044 A1 capacitor systems are known.

Embodiments provide capacitor components with improved electrical and mechanical properties. Specifically, embodiments provide a capacitor component with an improved thermal performance and an improved electrical integration into circuit environments. Further embodiments provide a capacitor component having a reduced system self-inductance and reduced spatial dimensions while maintaining a certain degree of mechanical stability. Yes further embodiments provide a capacitor component with an increased resistance against vibration and a capacitor component that allows a controlled gas diffusion to prevent overpressure inside a chamber.

Furthermore, additional embodiments provide a capacitor component compatible with usual voltage or current or current density requirements in DC-link systems, e.g. of electric vehicles.

The capacitor component comprises a first winding element and a heat sink. The first winding element is in direct thermal contact with the heat sink.

Such a capacitor component provides an improved thermal performance compared to conventional capacitor components where the winding is contained within an additional can, e.g. an aluminium can, that establishes a further heat conducting resistance element when heat should be dissipated from the winding element of a capacitor component to its environment such as an external heat sink.

Further, the direct integration of the first winding element of the capacitor component into the heat sink and the corresponding monolithic integration enhances mechanical stability and reduces spatial dimensions. The heat sink essentially functions as a housing for the first winding element of the capacitor component.

It is possible that the capacitor component comprises one or more additional windings elements which are also provided and adapted to be in direct thermal contact with the heat sink. The two or more winding elements of the capacitor component can be electrically connected in parallel to provide an increased capacity and an increased current density of the capacitor component.

Each of the winding elements can comprise a cathode foil and an anode foil and an electrical insulation between the two foils. Each of the two foils can be electrically connected to one of the two electrodes of the capacitor component. Specifically, the two electrodes of the capacitor component can be galvanically isolated from one another.

It is possible that one or more of the winding elements are selected from cylindrical windings and flat winding elements. Cylindrical windings can be obtained by stacking the foils and the insulator between the foils and by winding them into a cylindrical shape. A flat winding element can be obtained e.g. by winding the corresponding foils and insulator around a flat object such as a rectangular sheet, from a pressed round winding or by stacking the materials to obtain a winding element that has a substantially longer extension into two orthogonal lateral directions which are perpendicular to the axis of winding.

It is possible that the first winding element has two electrodes while one electrode can be in direct electric contact with the heat sink.

Such a configuration allows for small spatial dimensions and a good thermal coupling between the winding element and the heat sink. Further, the direct contact also allows for a high current density of the capacitor component.

Then the heat sink can act as one of the electrodes of the capacitor component. Specifically, the heat sink can act as the cathode of the capacitor component.

It is possible that the capacitor component further comprises a sealing for separating the winding element from the external environment.

The sealing can comprise a cover. The cover can comprise or consist of a material selected from a metal, a glass, a hard paper, a rubber layer.

The heat sink can comprise a cavity and an opening such that during manufacturing the winding element is inserted through the opening into the cavity. After inserting the winding element into the cavity, the respective opening is sealed in a sealing process utilizing the cover.

It is further possible that the cover comprises an insert or a ring comprising or consisting of rubber. Such an insert or ring allows the cavity to be sealed with the winding element inside in a simple manner such that an essentially hermetical sealing is obtained.

It is possible that the capacitor element further comprises a stabilization element. The stabilization element can be selected from a vibration-reducing element, a potting element, a mechanical latch, a rib and a pin.

The stabilization element can be monolithically integrated within the material of the heat sink. Further, it is possible that the stabilization element radially or axially compresses the winding element.

In particular, the stabilization element comprises or consists of the cover. For example, during manufacturing of the capacitor component, the capacitor component is sealed by pressing the cover through the opening into the cavity of the heat sink, where the winding element is arranged. By pressing the cover into the cavity, an axial force is exerted on the winding element that axially compresses the winding element, for example. In particular, this axial compression stabilizes the winding element mechanically.

For example, the stabilization element comprises further elements, such as ribs arranged along a circumference of the cavity, that can radially compress the winding element. In particular, the further elements can radially compress the winding element while the cover is pressed into the cavity, for example. Alternatively, or in addition, the winding element can be slightly deformed due to the axial compression, such that the heat sink exerts an additional radial force on the winding element, for example. Accordingly, the winding element can be axially compressed, radially compressed, or axially and radially compressed by the stabilization element.

Furthermore, the potting element or a potting material can mechanically stabilize the winding element. For example, the potting material, such as an epoxy or silicone, may glue the winding element to the heat sink while hardening or curing inside the cavity. In particular, the cavity can be open or sealed with the cover, for example, while the potting material cures.

In such a configuration the stabilization element protects the capacitor component and its constituent elements during phases of intense acceleration such as a mechanical resonance. Further, the stabilization element can be used to exert a certain degree of force such that the winding element is essentially pinned to its steady state position. Then, the arrangement of the winding element such that the winding element cannot change its position relative to the heat sink such that the mechanical stability is increased. Further, an additional improvement in thermal coupling the winding element to the heat sink is obtained and unfilled spaces within the heat sink are prevented such that the integration density, the capacity per unit volume and the current density per unit volume of the capacitor component are increased.

It is possible that the capacitor component comprises a corresponding opening side and a bottom side. At the opening side the opening towards the cavity is arranged. The bottom side can be arranged opposite to the opening side of the heat sink. The recess in the bottom side of the heat sink allows for the arrangement of the corresponding connection to one electrode of the two foils, e.g. an access to the cathode. The provision of the recess simplifies connecting the cathode while maintaining good stability and integration density.

It is possible that the electric coupling between the winding element and the heat sink is such that an ohmic resistance between the winding element and the heat sink is 0.6 mΩ or less compared to a single winding element capacitor component welded to a negative busbar through e.g. a soldering star element.

Further, it is possible that the capacitor component comprises a pressure relief element.

The pressure relief element can be realized as a diffusion membrane enabling pressure relief from the inside of the heat sink to the external environment.

Such a pressure relief element can act as a protective element preventing overpressure during operation of the capacitor component.

It is possible that the cathode foil is directly welded to the heat sink. Thus, the direct welding allows for a good thermal and electric coupling between the winding element and the heat sink such that good thermal and electric properties, specifically a high current density, are obtained.

It is possible that the heat sink comprises or consists of a material selected from aluminum and/or copper.

Further, it is possible that the first winding element comprises electrodes comprising or consisting of a material selected from aluminum and/or titanium and/or carbon.

Further, it is possible that the first winding element comprises a separator material between the electrodes when the separator material comprises or consists of a material selected from paper or synthetic fiber tissue or combination of both and the complete winding element can be impregnated with a liquid electrolyte, or impregnated/coated with a polymer dispersion or a combination of both.

Further, it is possible that the heat sink comprises a connection terminal for mechanically mounting and electrically connecting the heat sink to an external circuit environment.

Specifically, it is possible that the connection terminal is adapted to and provided for being mechanically mounted and electrically connected to a busbar, e.g. a busbar of a DC-link between an inverter and an energy source e.g. battery.

The capacitor component can have a longitudinal extension L, a first lateral extension W and a second lateral extension H. The longitudinal extension L is perpendicular to a longitudinal plane. The first lateral extension W is perpendicular to a transverse plane. The second lateral extension H is perpendicular to a frontal plane. The longitudinal extension L can be 10 mm or larger and 400 mm and smaller. The first lateral extension W can be 10 mm or larger and 150 mm or smaller. The third lateral extension H can be 10 mm or larger and 150 mm or smaller.

Specifically, it is possible that the capacitor component can be adapted to fit into a corresponding cuboid with the stated dimensions.

As stated above, the capacitor component can be used as a DC-link capacitor, e.g. in an electric vehicle, hybrid vehicle or power supply.

A method of manufacturing a capacitor component as stated above can comprise the steps of:
providing a heat sink and a first winding element,
inserting the winding element into the heat sink such that the first winding element is in direct thermal contact with the heat sink,
sealing the first winding element in the heat sink.

Further, it is possible that the direct thermal contact can be established via a welding process in which the first winding element or an electrode foil of the first winding element is welded to the heat sink.

The capacitor component can be an aluminum capacitor, a polymer electrolytic capacitor or a hybrid polymer electrolytic capacitor.

The heat sink can specifically serve as the cathode connection of the capacitor component.

The capacitor component can be compliant with customer applications such as 48-volt inverters, on-board chargers, power supplies and the like. However, the component is usable for high voltage applications, too. The capacity of the capacitor component can be between 100 and 20000 μF such as 3000 μF. The heat sink can comprise cooling fins or interfaces for electrically and thermally coupling the heat sink to a cooling circuit. Further, the heat sink can be adapted to and provided for being connected to a Peltier component or to a fan adapted to and configured to blow air to the heat sink.

Different options are possible for the manufacturing of the capacitor component. Specifically, it is possible that a single axial winding element is assembled using a cathode foil, an anode foil and a paper separator. Above and below the cathode foil to obtain a cylindrical shape of the winding element. Potting material can be used to mechanically fix the winding element within the heat sink.

A curling tool for sealing a capacitor component as described above has an active side for pressing a cover into the cavity and simultaneously curling the heat sink edge towards the cover to seal the cavity.

Specifically, the active side of the tool is structured such that one part of the active side is essentially parallel to the cover while another part of the active side is provided at an angle relative to the heat sink edge or a segment of the heat sink edge such that the heat sink edge or the heat sink edge element initially pointing towards the tool is bent towards the cover to permanently seal the cavity. Then, the bent edge or edge element permanently pushes-from the outside of the cavity—the cover towards the cavity.

### BRIEF DESCRIPTION OF THE DRAWINGS

Central working principles and details of the preferred embodiments are shown in the accompanying schematic figures.

FIGS. 1 and 2 show perspective views of capacitor components cut open and a possible curling tool for the purpose of better illustration;

FIGS. 3 and 4 illustrate possible arrangements of the foils and corresponding connecting tabs, whereas multiple tabs per foil are possible;

FIG. 5 illustrates elements of a capacitor component before sealing the cavity;

FIGS. 6 to 8 illustrate correspondingly sealed cavities;

Similarly, FIGS. 9 and 11 show elements of the capacitor component before sealing while corresponding FIGS. 10 and 12 and 13 show the sealed components;

FIG. 14 illustrates capacitor components with four individual windings element and a corresponding flat single winding element, respectively;

FIG. 15 illustrates a possibility of connecting the capacitor component to a busbar; and

FIGS. 16 to 21 illustrate further possibilities of mounting and electrically connecting the capacitor component to an external environment, e.g. a busbar.

### DETAILED DESCRIPTION OF ILLUSTRATIVE EMBODIMENTS

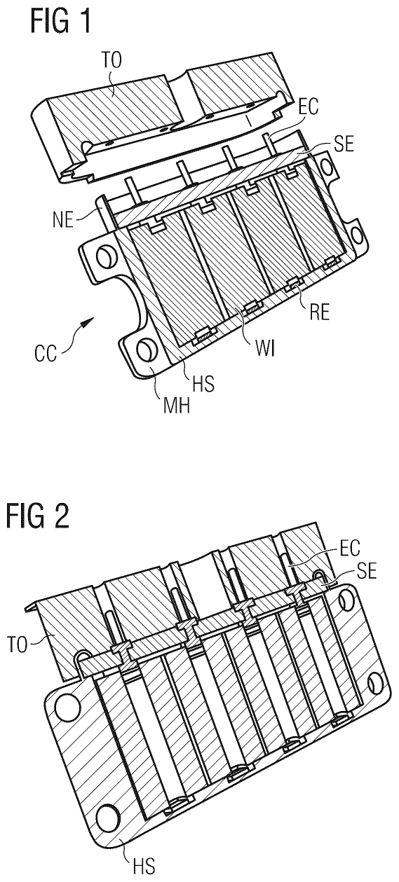

FIG. 1 shows a perspective view onto four capacitive elements, WI, contained in a common cavity of a heat sink HS. The heat sink HS comprises mounting holes MH to mechanically and electrically connect the heat sink HS to an external circuit environment. Further, at the bottom side of the heat sink HS the heat sink HS comprises recesses RE. Specifically, for each winding element WI there is one recess RE that simplifies routing the cathode electrode to the heat sink HS of the capacitor component CC. Further, at the opening of the cavity of the heat sink HS a sealing element SE is arranged. There is a common sealing element SE for each of the four winding elements WI. The sealing element SE contains four holes via which the electrical contacts EC can be led to the outside of the capacitor component CC.

Additionally, FIG. 1 illustrates a possible tool for sealing the cavity of the capacitor component CC. The tool TO can be used to press the sealing SE into a position above the winding elements WI such that the sealing SE is embedded in a lateral direction by a neck NE of the heat sink HS.

FIG. 2 illustrates a similar configuration where the mounting holes MH are provided in a different shape. Further, FIG. 2 illustrates a cross-section through the possible sealing scenario SE such that the through holes establishing the connection to the external contacts EC are visible.

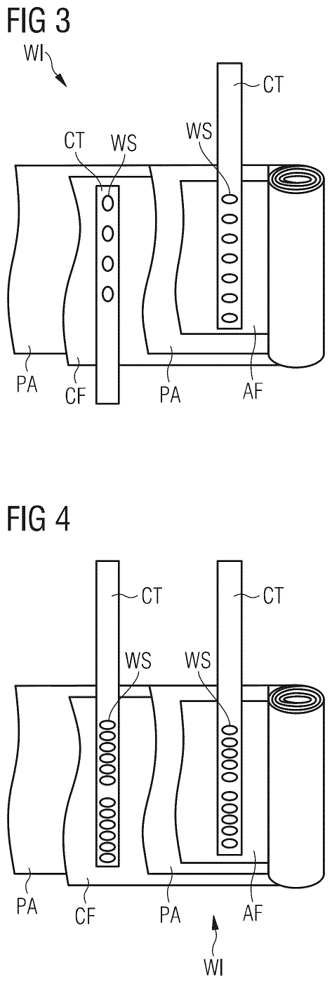

FIGS. 3 and 4 show the internal construction of a corresponding winding element WI. The winding element comprises a cathode foil CF and an anode foil AF and a corresponding paper sheet PA arranged between the two foils CF, AF. Further, an additional paper foil PA is arranged “behind” the cathode foil CF. further, the winding element comprises connecting tabs CT (single or multiple per foil) for establishing a contact to an external environment. Specifically, the cathode foil CF can be electrically connected to the heat sink HS while the anode foil AF can be electrically connected via the connecting tabs that may be arranged through the sealing SE. Further, the connecting tabs CT and the corresponding foils CF, AF, can be electrically and mechanically connected via welding spots WS. Welding can be performed via cold pressure welding.

FIG. 4 illustrates a similar configuration. However, both connecting tabs CT are arranged towards the same side of the winding element.

Thus, FIG. 3 show single axial winding element as well as FIG. 4 show snap-in winding element assembled via winding of the corresponding foils. Within the capacitor component the winding elements can be mechanically fixed, e.g. using welding of the connection tabs to the heat sink in case of axial winding element or using a potting material for fixation.

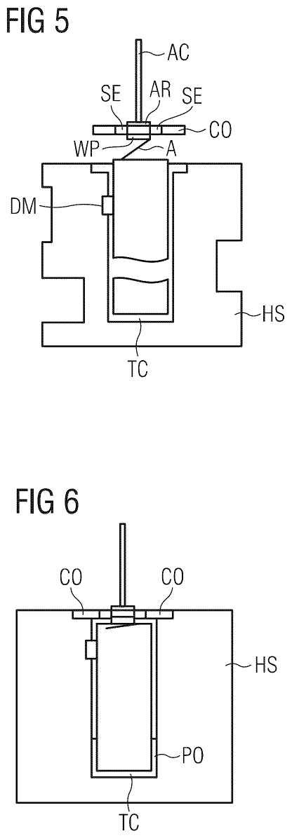

FIGS. 5 and 6 illustrate a possibility of sealing the cavity against the external environment of the capacitor component. FIG. 5 illustrates a sealing SE comprising glass, rubber or a plastic insulation. An anode rivet is arranged in the center of the sealing SE. Via the anode connection AC the anode of the winding element can be accessed to from an external circuit environment. In this case the heat sink HS establishes the cathode connection.

Further, a diffusion membrane DM is optionally provided such that an overpressure can be relieved.

Welding points WP can be used to connect connection tabs of the winding element to the external anode connection AC.

Correspondingly, FIG. 6 shows the configuration described earlier in a sealed state where the sealing is essentially arranged flush with the top side of the heat sink HS. Optionally, a potting material PO mechanically stabilizes the bottom section of the winding element within the heat sink HS. The cover CO can be welded to the heat sink to establish an essentially hermetical sealing.

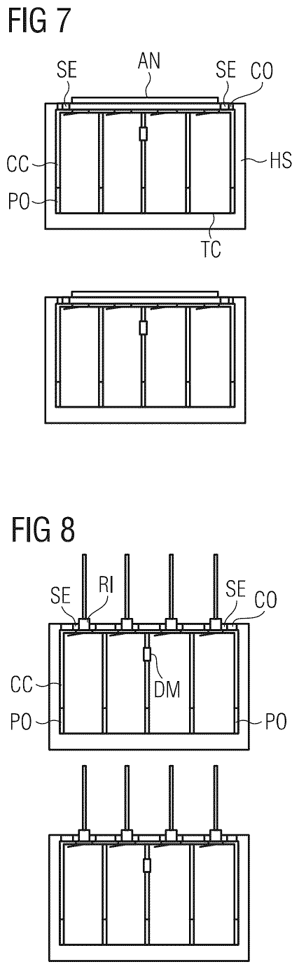

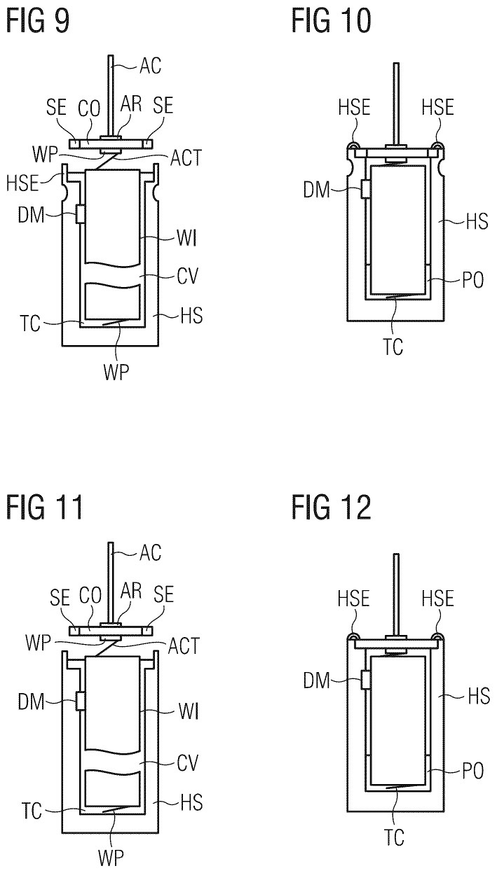

While FIGS. 5 and 6 essentially illustrate capacitor components with a single winding element, FIGS. 7 and 8 illustrate capacitor components with a plurality of winding elements, e.g. four winding elements. In FIG. 7 the capacitor component comprises a flat common anode AN while in the configuration according to FIG. 8 each of the four winding element has its own anode connection to the circuit environment.

The bottom parts of FIGS. 7 and 8 illustrate the possibility of providing individual separations between the winding elements within the separate cavities within the heat sink.

FIGS. 9 and 10 illustrate open and closed versions of a single winding capacitor component where, in the closed state, a heat sink edge HSE is curled onto the top side of the cover to secure the sealing.

Specifically, a curling tool TO as shown in FIGS. 1 and 2 can be used for sealing the cavity. The tool TO has an active side arranged towards the capacitor component. The tool TO is usable for pressing the cover into the top part of the cavity and simultaneously curling the heat sink edge HSE towards the cover CO to seal the cavity CV. The active side of the tool is structured such that one part of the active side is essentially parallel to the cover while another part of the active side is provided at an angle relative to the heat sink edge segment such that the heat sink edge segment initially pointing towards the tool is bent towards the cover to permanently seal the cavity. Then, the bent edge or edge element permanently pushes-from the outside of the cavity-the cover towards the cavity.

FIGS. 11 and 12 show the possibility of providing the cover in the form of a hard paper with a rubber layer and the option of providing an inner protective layer curled with the case wall.

FIG. 13 shows the corresponding sealing method utilizing hard paper in a version of the capacitor component with a plurality of four windings element contained in the common cavity of the heat sink HS.

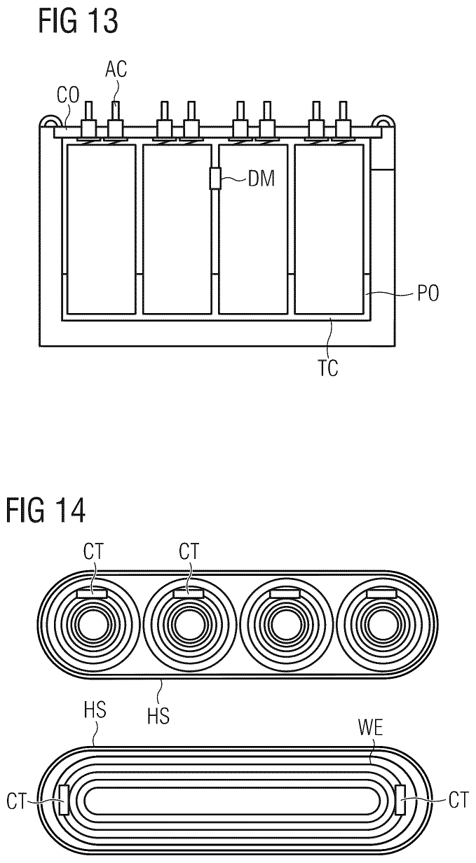

FIG. 14 illustrates the possibilities of arranging a plurality of cylindrical winding elements which have a connection tab CT each and the possibility of arranging a single flat winding element within the cavity of the heat sink HS. In the case of arranging a single flat winding element within the cavity of the heat sink, the flat winding element may have a plurality of connection tabs arranged at the top side of the heat sink HS. Multiple flat winding elements are also possible in similar configuration.

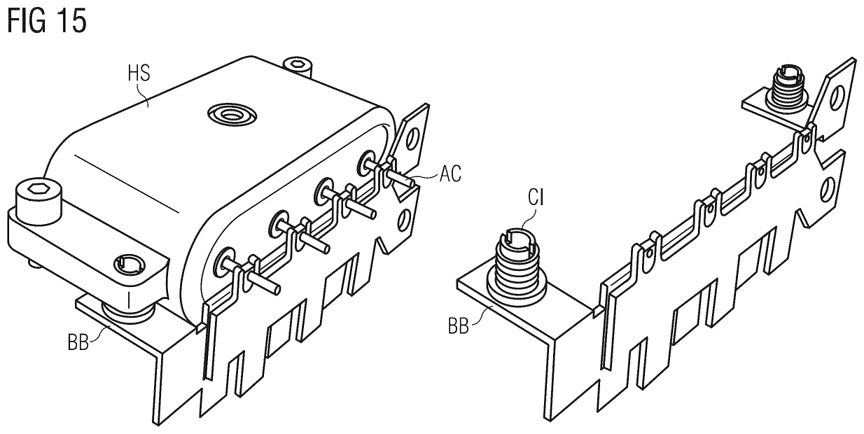

FIG. 15 illustrates a possibility of mounting the body of the capacitor component essentially realized by the heat sink HS to an external circuit environment, in particular the busbar BB. The connection is established via a connection insert CI, e.g. a copper insert, into the busbar BB such that the copper insert is screwed into the heat sink, e.g. into the aluminum body of the heat sink.

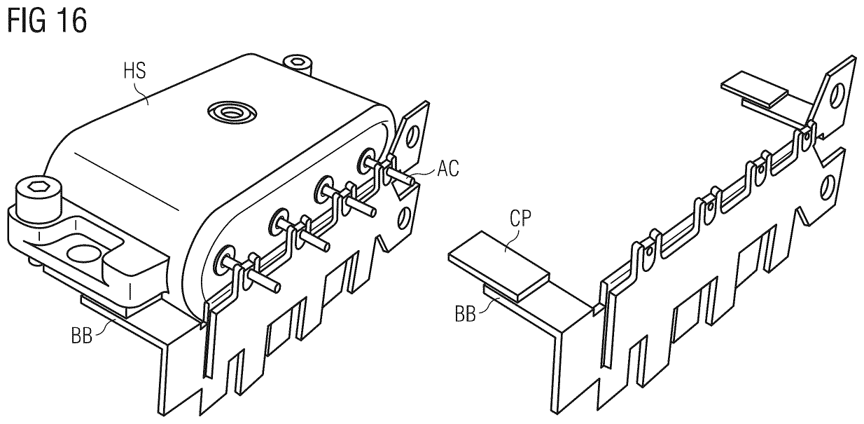

In contrast, FIG. 16 shows the possibility of providing a contact plate CP at the busbar BB such that a corresponding connection area of the heat sink HS can be welded to the connection plate CP of the busbar BB.

FIG. 17 shows a further possibility of mounting the heat sink HS to the busbar BB: Each longitudinal side of the heat sink HS can be secured to corresponding mounting areas via e.g. two screws SC.

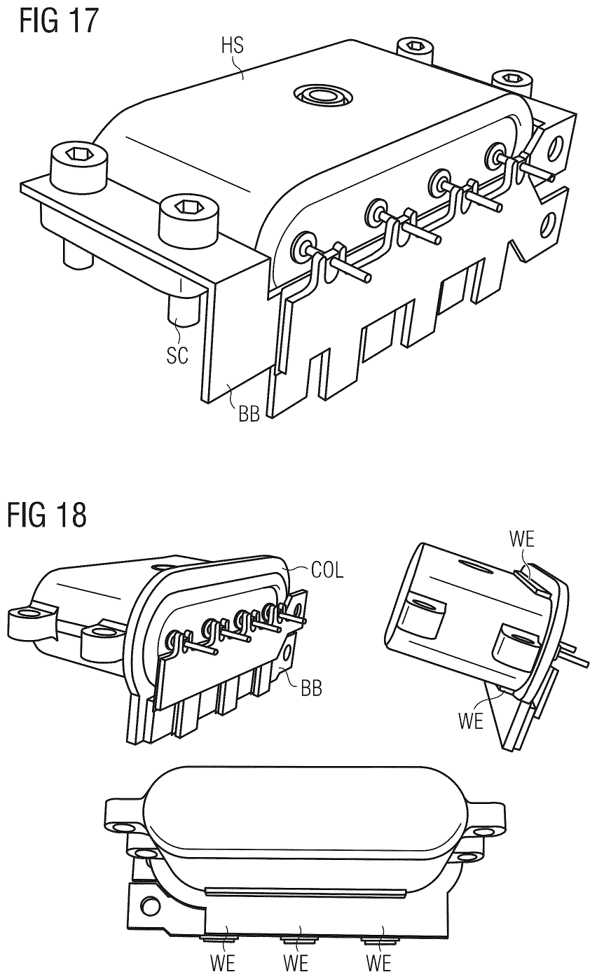

FIG. 18 illustrates further perspective views of the mounting method shown in FIG. 17. Specifically, FIG. 18 shows the possibility of providing a collar COL to the top side at the sealing of the heat sink HS such that the collar COL provides a connection area to be connected to the busbar.

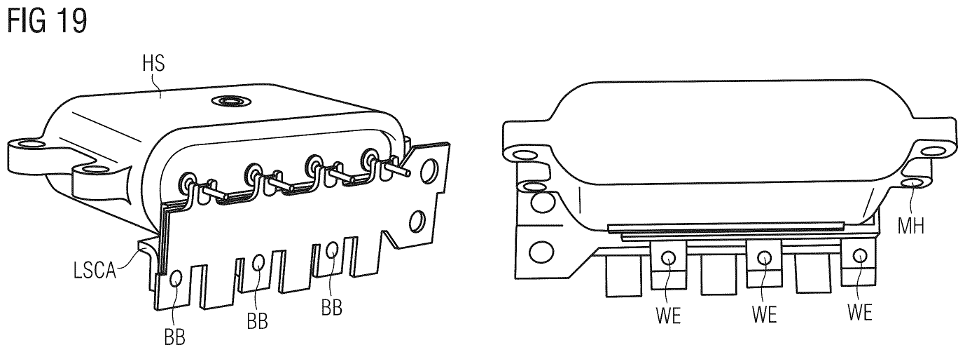

FIG. 19 shows a further possibility of mounting the heat sink HS to the busbar BB: The heat sink HS comprises L-shaped connection areas LSCA such that the busbar BB is welded to the vertical sections of the L-shaped connection areas. The number of welding points can be one, two, three, four and more. Specifically, a plurality of two or more is preferred to stabilize the mounting areas against torque forces.

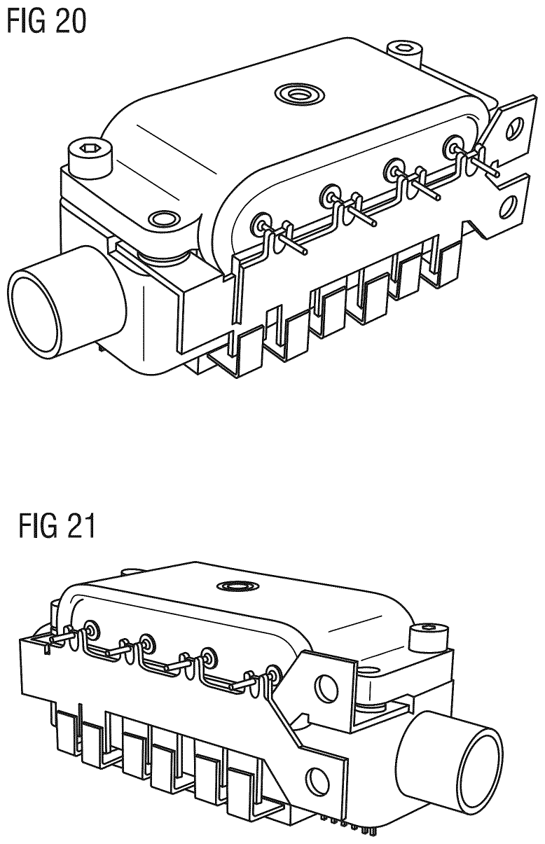

FIGS. 20 and 21 illustrate further degrees of integrating the capacitor component into external systems such as the system cooling circuit (e.g. water cooling, air cooling) and semiconductors.

The capacitor component is not limited by the technical features described above or shown in the figures. The capacitor component can comprise further mounting connections and electrical connections to further integrate and connect the capacitor component electrically and mechanically into an external environment.

1.-25. (canceled)

26. A capacitor component comprising:
a first winding element; and
a heat sink,
wherein the first winding element is in direct thermal contact with the heat sink.

27. The capacitor component according to claim 26, further comprising one or more additional winding elements in direct thermal contact with the heat sink.

28. The capacitor component according to claim 27, wherein the winding elements are selected from cylindrical windings and/or flat windings and/or stacks.

29. The capacitor component according to claim 26, wherein the first winding element has two electrodes and one electrode is in direct electric contact with the heat sink.

30. The capacitor component according to claim 29, wherein the heat sink establishes an external contact of the capacitor component.

31. The capacitor component according to claim 26, further comprising a sealing for separating the first winding element from an external environment.

32. The capacitor component according to claim 31, wherein the sealing comprises a cover comprising a material selected from a metal, a glass, a hard paper, a rubber layer or combinations of these.

33. The capacitor component according to claim 32, wherein the cover further comprises an insert or a ring comprising rubber, plastic or glass.

34. The capacitor component according to claim 26, further comprising a stabilization element selected from a vibration reducing element, a potting element, a mechanical latch, a rib or a pin.

35. The capacitor component according to claim 34, wherein the stabilization element is monolithically integrated within a material of the heat sink and/or radially or axially compresses the first winding element.

36. The capacitor component according to claim 35, further comprising an opening side and a bottom side, and wherein a recess is located in the bottom side.

37. The capacitor component according to claim 26, wherein an ohmic resistance between the first winding element and a negative busbar is 0.6 m (or less.

38. The capacitor component according to claim 26, further comprising a pressure relief element.

39. The capacitor component according to claim 38, wherein the pressure relief element is a diffusion membrane enabling pressure relief from an inside of the heat sink to an external environment.

40. The capacitor component according to claim 26, further comprising a cathode foil directly welded to the heat sink.

41. The capacitor component according to claim 26,
wherein the heat sink comprises or consists of a material selected from Cu and/or Al,
wherein the first winding element comprises electrodes comprising or consisting of a material selected from Al, Ti, carbon and/or combinations thereof,
wherein the first winding element comprises an separator material between the electrodes,
wherein the separator material comprises or consists of a material selected from paper or synthetic fiber tissue or a combination thereof, and
a complete winding element is impregnated with a liquid electrolyte, or impregnated/coated with a polymer dispersion, or a combination of both.

42. The capacitor component according to claim 26, wherein the heat sink comprises a connection terminal configured for mechanically mounting and electrically connecting the heat sink to an external environment.

43. The capacitor component according to claim 42, wherein the connection terminal is configured for being mechanically mountable and electrically connectable to a bus bar.

44. The capacitor component according to claim 26, wherein the capacitor component has a longitudinal extension L perpendicular to a longitudinal plane, a first lateral extension W perpendicular to a transverse plane, and a second lateral extension H perpendicular to a frontal plane with
10 mm≤L≤450 mm,
10 mm≤W≤100 mm, and
10 mm≤H≤100 mm.

45. A method for fixing the winding elements of the capacitor component according to claim 27, the method comprising:
using a non-cylindrical cover disc comprising a rubber layer;
pressing an open end of the heat sink into the rubber layer of the cover disc conformally along a circumference of the cover disc;
pressing the winding elements against a bottom of the heat sink thereby providing a tight sealing for the winding elements inside the heat sink and a mechanical fixation of the winding elements; and
controlling a pressing force for fixing the winding elements by a fixed distance between the cover disc and the bottom of the heat sink.

46. The capacitor component according to claim 26, further comprising a connection between the heat sink and a copper busbar using one of the following methods:
via a screwing connection with a washer element, wherein the washer is made from a copper-aluminum clad material, and wherein the washer is placed so that a copper part is in contact with the copper busbar and an aluminum part is in contact with the heat sink;
via a direct welding contact of the copper busbar and the heat sink by friction stir welding;
via a copper strip/plate that is welded to the heat sink and the copper busbar is connected to the copper strip/plate;
via a copper insert that is tightly fit into a hole in the heat sink by turning and pressing and the copper busbar is connected onto the insert; or
via a copper-clad dual material strip/plate/busbar that is connected to the heat sink so that an aluminum part is connected to the heat sink and a copper part is free to connect to the copper busbar.

47. The capacitor component according to claim 26, wherein a thermal contact between a capacitive element surface and the heat sink has a thermal contact resistance lower than 6 K/W.

48. A DC-link capacitor comprising:
the capacitor component according to claim 26.

49. A method for manufacturing the capacitor component according to claim 26, the method comprising:
inserting the first winding element into the heat sink such that the first winding element is in direct thermal contact with the heat sink; and
sealing the first winding element in the heat sink.

50. A curling tool for sealing the capacitor component according to claim 26, the curling tool comprising:
an active side for pressing a cover into a cavity; and
simultaneously curling a heat sink edge towards the cover to seal the cavity.
